(19) United States
(12) Patent Application Publication
(10) Pub. No.: US 2004/0210646 A1
(43) Pub. Date: Oct. 21, 2004

(54) Information processing system

(75) Inventors: Yuji Sushima, Hachioji (JP); Tsuyoshi Tanaka, Kokubunji (JP); Keitaro Uehara, Kokubunji (JP); Naoki Hamanaka, Tokyo (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/758,115

(22) Filed: Jan. 16, 2004

(30) Foreign Application Priority Data
Apr. 17, 2003 (JP) 2003-112843

(51) Int. Cl. G06F 15/177

(52) U.S. Cl. 709/220

(57) ABSTRACT

The present invention relates to system construction, and operations management, provided by a plurality of servers in an information processing system, and more particularly to a technology for reducing the burden on a system administrator for system construction and operations management. If, in an information processing system in which a plurality of server modules and a storage module are interconnected via a network, configuration information transmitted to the storage module from the server modules at startup complies with the configuration requirements for operating services retained by the storage module and the system configuration information corresponding to the number of server modules for service operation, the system gives a host name, which is unique to the information processing system, to a server module from which the configuration information is transmitted,and assigns a service designated by the corresponding information to the server module, transmits the service, and changes the number of units related to the corresponding information.

### FIELD OF INVENTION

The present invention relates to the management and operation of servers in a network.

### PRIORITY CLAIM

The present invention claims priority under 35 U.S.C. §119 to Japanese patent application P2003-112843 filed Apr. 17, 2003 the entire disclosure of which is hereby incorporated by reference.

### BACKGROUND OF THE INVENTION

The present invention relates to system construction and operations management for an information processing system in which a plurality of servers provide an information service, and more particularly to a technology for reducing the burden on a system administrator for system construction and operations management.

An OS and server application are installed in the storage of a convention server. The server exercises its functionality when the OS and server application starts upon power-on or reset. For configuring or reconfiguring a system comprising a large number of servers, it is necessary to install an OS and server application on each server or adjust the settings for the currently installed OS and server application. Therefore, a heavy burden is imposed on a server administrator and errors are likely to occur because manual operations need to be performed. These problems have become an obstacle to prompt system changes.

There are the following conventional technologies as regards the above problems.

When a first conventional system change method is used, servers, storage device, firewall, and other information processing system component elements are interconnected via a network, and only necessary component elements are assigned in accordance with an operations configuration that is specified by operator instructions. Further, the disks built in the servers are disabled with the startup disks are installed together on a boot server. Server function changes resulting from operations configuration changes can then take effect simply upon a restart. The necessity of performing a reinstallation or making setting adjustments is then eliminated with a view toward reducing the burden on the server administrator (refer to Nonpatent Document 1, Hewlett-Packard Company, “technical white paper hp utility data center”, [online] October 2001, Internet <URL: http://www.hp.com/large/infrastructure/utilitycomputing/images/UDCTechWhitePaper.pdf as an example).

When a second conventional system change method is used, the OS and data for the client side within a server/client system are positioned together on the server side so that an installation or boot procedure is performed for the client side via a network. Since this furnishes the server side with a boot image, OS changeover, patching, and other similar operations can be completed merely by performing required procedures on the server-side. Further, the necessity of performing setup for each client is eliminated so as to reduce the burden on the system administrator (refer to Patent Document 1, JP-A No. 222910/1994 as an example).

Also see Patent document 2, U.S. Pat. No. 5,555,416 which describes a boot device system.

### SUMMARY OF THE INVENTION

When the conventional system described in Nonpatent Document 1 above is used for system construction, the system administrator must manually specify, i.e., a human must make a selection, which OS and application are to be assigned to each physical server. Therefore, the system administrator must finalize a scheme for system construction, for instance, by manually investigating and considering the server performance, installed memory size, and connected I/O devices.

Meanwhile, the invention disclosed by Patent Document 1 above has the same features as the first conventional technology in that client side OSes are consolidated into the server side. However, this invention cannot perform assignment in accordance with the CPU performance, installed memory size, and other client side properties although it permits a client to function as a server. As a result, the system administrator must assign functions in accordance with the server performance, installed memory size, connected I/O devices, and other conditions.

In consideration of the problems described above, the present invention provides an information processing system that is capable of automatically assigning an OS (Operating system) and application in accordance with the server performance, installed memory size, connected I/O devices, and other conditions, lessening the burden on the system administrator, and reducing human labor requirements with a view toward minimizing the possibility of error occurrence.

The present invention separates a service comprising an OS and application for server module operation from individual server modules and consolidates the services of server modules within the entire system into a storage module.

Upon reset or power-on, each server module transmits its own configuration information (CPU type, CPU performance, installed CPU count, installed memory size, connected I/O devices, and other items of information) to the storage module. Upon receipt of the configuration information, the storage module transmits a service to a server module having configuration information that matches preselected system configuration information. Upon receipt of a service from the storage module, the server module automatically starts up.

### BRIEF DESCRIPTION OF THE DRAWINGS

FIG. 1 is a block diagram illustrating an information processing system according to one embodiment of the present invention;

FIG. 2A is a block diagram showing an example of a server module configuration according to one embodiment of the present invention;

FIG. 2B is a block diagram showing an example of a server module configuration according to one embodiment of the present invention;

FIG. 3 is a block diagram illustrating a server module configuration according to one embodiment of the present invention;

FIG. 4 is a sequence diagram illustrating a processing sequence that is followed by a first embodiment of the present invention;

FIG. 5 is an explanatory diagram illustrating the contents of a configuration information notification packet according to the first embodiment of the present invention.

FIG. 6 is an explanatory diagram showing an example of system configuration information according to the first embodiment of the present invention;

FIG. 7 is a block diagram showing a typical system configuration according to the first embodiment of the present invention;

FIG. 8 is an explanatory diagram showing an example of performance conversion data according to the first embodiment of the present invention;

FIG. 9 is a sequence diagram illustrating a processing sequence that is followed in accordance with the first embodiment of the present invention when an “unassigned” error occurs;

FIG. 10 is a hierarchy diagram illustrating a server module configuration according to a second embodiment of the present invention;

FIG. 11 is an explanatory diagram illustrating a configuration information notification packet according to the second embodiment of the present invention;

FIG. 12 is an explanatory diagram showing an example of server use according to the second embodiment of the present invention;

FIG. 13 is a sequence diagram illustrating a processing sequence that is followed in accordance with a third embodiment of the present invention; and

FIG. 14 is a sequence diagram illustrating a processing sequence that is followed in accordance with the third embodiment of the present invention when a “mismatch” error occurs.

### DETAILED DESCRIPTION OF THE PREFERRED EMBODIMENTS

The present invention predefines the logical server configuration connection relationship and count as system configuration information. This permits the storage module to automatically assign an OS and application to a server module that is required for execution. It is therefore possible to achieve system construction without manually paying undue attention, for instance, to the performance characteristics of installed server modules, thereby reducing the burden on a server system administrator.

Embodiments of the present invention will now be described with reference to the accompanying drawings.

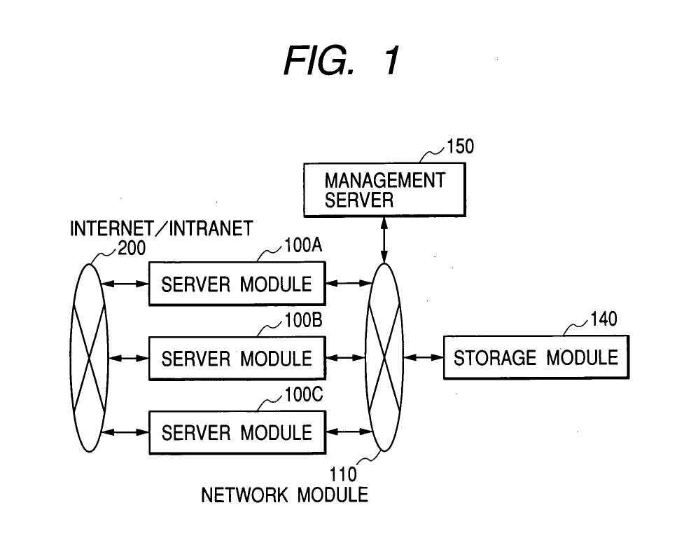

FIG. 1 is a block diagram that schematically illustrates a first best mode preferred embodiment of an information processing system according to the present invention.

Three server modules (100A, 100B, and 100C) are connected to a storage module 140 via a network module 110. Each server module 100 is directly connected to Internet/intranet 200. Further, a management server 150, which is used by a network administrator for operation purposes, is connected to the network module 110.

Each server module 100 is a computer that performs a process for the information processing system. It is capable of exercising various functions (e.g., Web server, application (AP) server, and database (DB) server functions) depending on the employed OS and application. The number of service modules 100 is not limited to three. Further, each server module 100 need not be directly connected to the Internet/intranet 200.

The storage module 140 is a computer that is equipped with an internal storage. Upon request from a server module 100, the storage module 140 transmits/receives data retained in the storage.

The management-server 150 is a management computer that allows a network administrator to enter system configuration information or other information about the information processing system and transmit it to the storage module 140 or receives system configuration error information or other information from the storage module 140 and reports it to the network administrator. The management server 150 can be substituted by any server module 100 and is not essential to the system of the present embodiment.

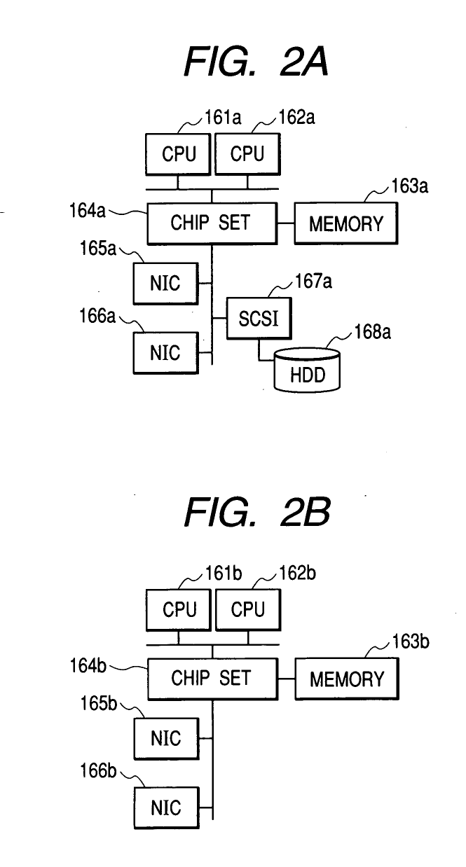

FIGS. 2A and 2B illustrate the configuration of a server module 100 for use in the present embodiment.

In FIG. 2A, a plurality of CPUs (161a and 162a), which each serve as a server module, are connected to a memory 163a, which is a storage device, through a chipset 164a. The chipset 164a is connected via an I/O bus to network interface cards (NICs) (165a and 166a) , which each serve as a network interface, and a SCSI card 167a, which serves as an interface with an external device (particularly a disk drive). The SCSI card 167a is connected to a hard disk drive (HDD) 168a. Two NICs are connected so that one of them can be connected to the Internet/intranet, whereas the other one can be connected to the network module 110.

The configuration shown in FIG. 2B is basically the same as the one shown in FIG. 2A except that the SCSI and HDD are both excluded from the configuration shown in FIG. 2B. The configurations shown in FIGS. 2A and 2B are both applicable to the server modules 100 according to the present embodiment.

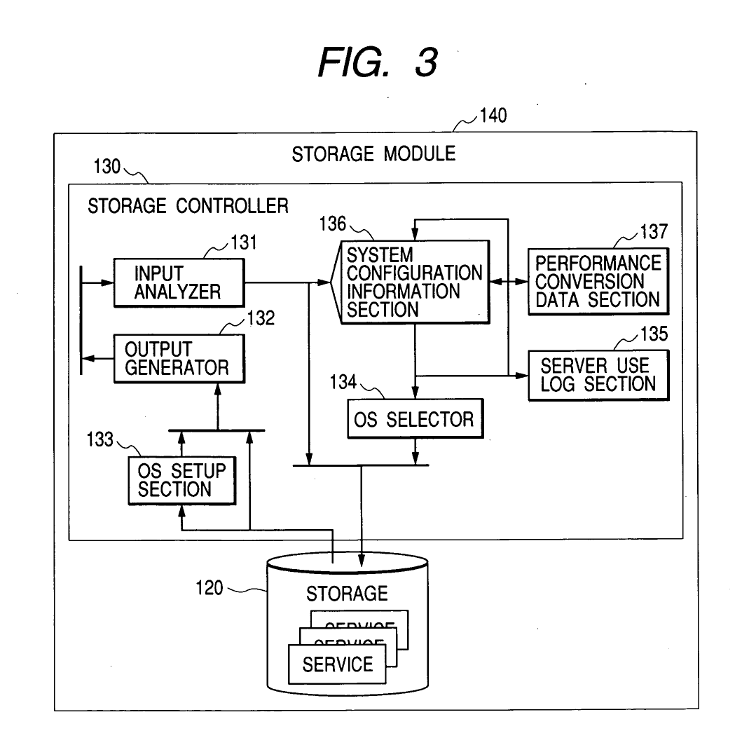

FIG. 3 illustrates the configuration of the present embodiment of the storage module 140.

The storage module 140 includes a storage 120 and a storage controller 130, which controls the storage 120. The storage 120 is used to store an OS, application, and data (hereinafter referred to as “a service” or “services”).

The storage controller 130 comprises an input analyzer 131 and an output generator 132 for exercising control over the connection to the network module 110. The storage controller 130 further comprises an OS setup section 133 for OS setup, an OS selector 134 for OS selection, a server use log section 135 for acquiring the information about server use, a system configuration information section 136 for retaining system configuration information which will be described later, and a performance conversion data section 137 for recalculating the CPU performance of a server module.

The configuration of the first embodiment has been described thus far. The operation of the first embodiment will now be described.

The present invention separates services for operating the server modules 100 from the individual server modules, consolidates the services 121 of server modules 100 within the entire system into the storage module 140. Each server module 100 starts up when it receives a service from the storage module 140 via the network module 110.

The storage module 140, which stores services 121, uses its system configuration information section 136 to store system configuration information, which indicates conditions necessary for service execution (CPU type, CPU performance, installed-CPU count, installed memory size, connected I/O devices, and other items of information).

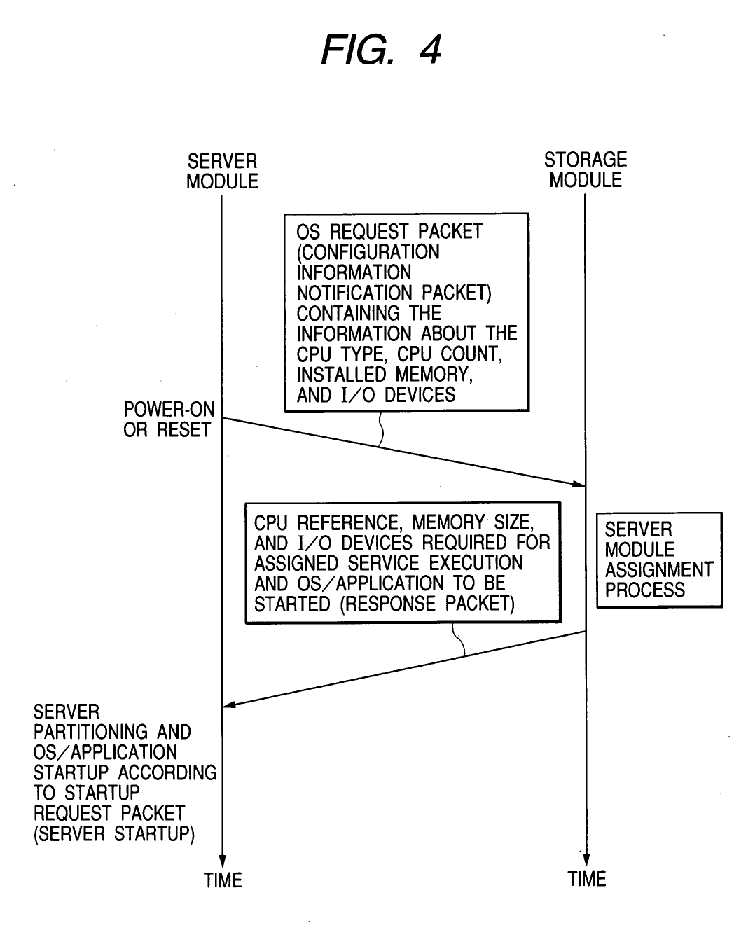

FIG. 4 is a sequence diagram illustrating a processing sequence that is followed by the present embodiment of the information processing system.

Upon reset or power-on, a server module 100 transmits a configuration information notification packet, which contains its own system configuration information (CPU type, installed CPU count, installed memory size, connected I/O devices, and other items of information), to the storage module 140.

Upon receipt of the configuration information notification packet, the storage module 140 references the information about the packet and performs a server module analysis process in order to decide on a server module service. Through the server module analysis process, the storage module 140 selects a service that matches the system configuration information about the server module from which the configuration information packet is transmitted, determines the type of service to be started in the server module 100 and the resource to be assigned, and transmits a response packet, which contains an OS, application, and other necessary data, to the server module 100. For such a response, the storage module 140 also sets up the host name and other information unique to each server module 100.

Upon receipt of the response packet, the server module 100 achieves server startup in accordance with the data contained in the response packet. The storage module 140 assigns the service to all server modules 100.

If the storage module 140 does not transmit a response packet within a predetermined period of time after it receives a configuration information notification packet from a server module 100, the server module 100 retransmits the configuration information notification packet. If a predetermined transmission count is exceeded, an error is reported to the management server 150. An error is also reported to the management server 150 if the assignment of a server module matching the system configuration information stored by the storage module 140 fails.

The aforementioned server module analysis process will now be described in detail with reference to the configuration diagram shown in FIG. 3.

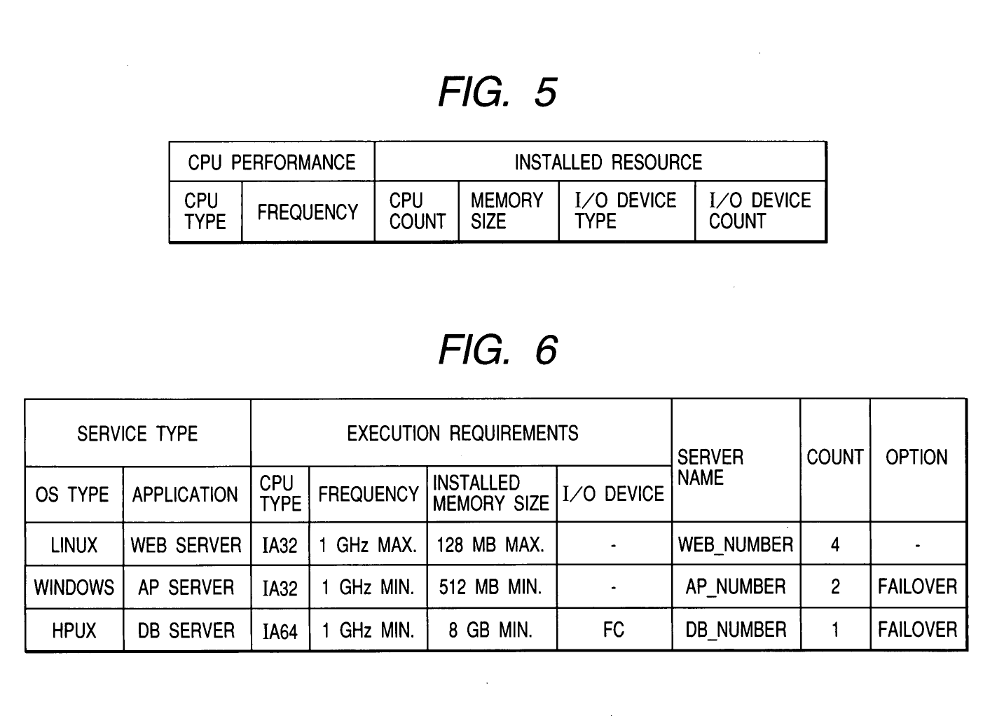

The input analyzer 131 of the storage module 140 analyzes a packet transmitted from the network module and determines whether the entered packet is a configuration information notification packet. The configuration information notification packet contains not only a network ID (IP address, MAC address, and other items of information for use with TCP/IP), which accompanies a packet used for communication purposes, but also the configuration information (which will be described later with reference to FIG. 5) about a CPU and memory installed in a server module 100 from which the packet has been issued, and I/O devices connected to the server module 100.

If the packet is not a configuration information notification packet, the input analyzer 131 directly accesses the storage 120. Further, the response to the packet returns directly to the packet transmission source without going through the OS setup section 133.

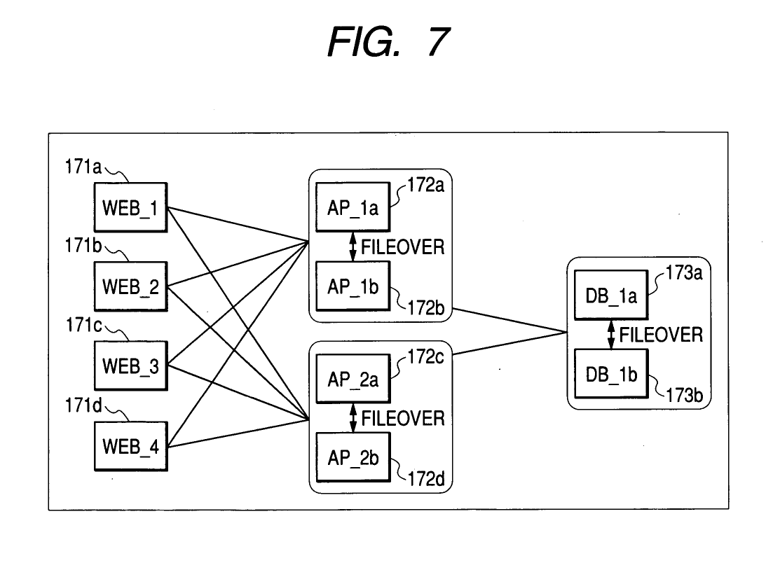

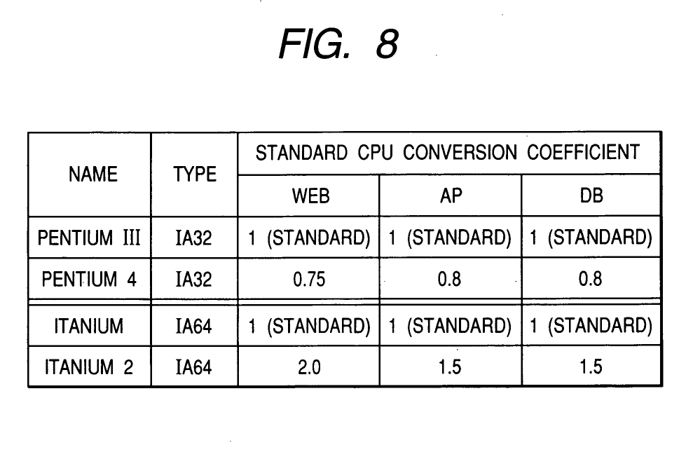

If the packet is found to be a configuration information notification packet, the storage controller 130 inquires about the system configuration information (which will be described later with reference to FIG. 6) stored in the system configuration information section 136 in accordance with the CPU performance and installed resource described by the configuration information, and determine the type of service to be assigned to the server module 100 from which the configuration information notification packet is issued. If a configuration matching the CPU performance and installed resource indicated by the configuration information about the server module 100 is not found at the time of system configuration information search for decision or if the available performance is not adequate for operating the resource installed on the server module 100, the performance conversion data (which will be described later with reference to FIG. 8) stored in the performance conversion data section 137 may alternatively be referenced to replace the system configuration information and determine an operative configuration.

When the type of service is determined, the OS selector 134 selects an appropriate service 121 from those which are stored in the storage 120, and then reads the selected service. In this instance, the server use log section 135 records information that indicates what service is assigned to which server module.

Next, the OS setup section 133 performs service setup for the OS and application contained in the data about the determined service in accordance with the host name included in the system configuration information. This setup process is performed to predetermine the network host name for the OS and application and automatically activate the host name on a network when the server module 100 starts up.

Next, the resulting setup data is delivered to the output generator 132 and placed in a packet that can be transmitted to the network module 110. The packet obtained in this manner is then transmitted as a response packet to the server module 100 from which the aforementioned configuration information notification packet was transmitted.

Due to the above process, the storage module 140 can automatically assigns an appropriate service in accordance with the configuration information notification packet transmitted by the server module 100 and transmit the service to the server module 100 via a network at startup of the server module 100. As a result, the server module 100 can start the received service.

FIG. 5 shows the details of configuration information that is contained in the configuration information notification packet, which is transmitted by the aforementioned server module. The CPU performance information includes the information about the CPU type and CPU frequency. The installed resource information includes the information about the number of installed CPUs, installed memory size, and connected I/O device types and quantities. The configuration information notification packet may contain information other than the configuration information shown in FIG. 5.

FIG. 6 shows an example of the structure of system configuration information that is stored by the system configuration information section 136 of the storage module 140, which is described earlier.

System configuration information recordings correspond to a.“service type” which indicates a set of an OS and application to be assigned to a server module, a server's “execution requirements” for executing the service type, a “server name” which represents the host name to be set for the server module, a “count” which indicates the required number of server modules, and an “option”.

The information about the “service type” comprises an OS type (e.g., Linux or Windows (registered trademark)) and an application type (e.g., Web server or database server).

The “execution requirements” represent device performance requirements that a server module must satisfy for service execution purposes. The information about the execution requirements comprises the information about a CPU type, CPU frequency, installed memory size, and I/O devices.

The “server name” is a host name that is set up when a service is assigned to a server module 100. The number indicated in the server name column is a number that is dynamically assigned when a service is assigned to a server module 100. This number is incremented each time a service is assigned to a server module 100. Therefore, even-when some server modules 100 are in charge of the same service type, the resulting host names differ from each other. If, for instance, the employed configuration contains four Web servers, their names are “Web_{—}01”, “Web_{—}02”, “Web_{—}03”, and “Web_{—}04”.

The “count” indicates the required number of server modules that satisfy the server module execution requirements. In the example shown in FIG. 6, four units, two units, and one unit of a server module are assigned respectively as Web, AP, and DB service types which are based on the Web three-layer model and frequently used for business server systems.

The “option” is used to specify a high-reliability option, which invokes failover (provides device duplexing or other form of device redundancy). In the example shown in FIG. 6, the failover option is specified for an AP server and DB server to which high reliability is essential. Some other necessary option for system construction may be specified instead of the failover option.

FIG. 7 shows an example of a system configuration diagram that corresponds to the system configuration information presented in FIG. 6.

Within the configuration shown in FIG. 7, server modules 171a, 171b, 171c, and 171d are defined as Web servers; server modules 172a, 172b, 172c, and 172d as AP servers; and server modules 173a and 173b as DB servers. Server modules 171a and 171b, server modules 171c and 171d, and server modules 173a and 173b respectively form a failover configuration, that is, a duplex configuration. Further, a unique host name is given to each server module 100.

The system configuration diagram like the one shown in FIG. 7 is to be prepared by a system administrator at the time of information processing system design. In accordance with the system configuration diagram, the system configuration information (FIG. 6) states the server module execution requirements for each service.

In other words, when the system administrator sets system configuration information, like the information shown in FIG. 6, for the storage module 140, an information processing system in which the system configuration shown in FIG. 7 automatically starts is obtained.

FIG. 8 shows an example of performance conversion data, which is stored by the aforementioned performance conversion data section 137. The performance conversion data is stored as a conversion coefficient relative to a standard CPU. This conversion coefficient represents the ratio of performance per frequency to the standard CPU, which is prevalent when an application to be executed for each type of service defined by the system configuration information or a program equivalent in properties to such an application is executed in situations where the standard CPU is set up for each type and generation of CPUs.

The example presented in FIG. 8 shows the performance-per-frequency ratio of Web, AP, and DB services concerning Pentium (registered trademark) CPUs and Itanium (registered trademark) CPUs, which are standard CPUs having Intel Architecture (IA) 32 or 64. The example indicates that the coefficient representing the performance requirements for a Web server is 1 for Pentium III, 0.75 for Pentium 4, or 2.0 for Itanium 2. When the values are recalculated in terms of frequency, the performance delivered by a 1 GHz Pentium III CPU is equivalent to that is delivered by a 750 MHz Pentium 4 CPU and that is delivered by a 2 GHz Itanium CPU.

When the above performance conversion data is used, the server module execution requirements (see FIG. 6) can be defined by setting a standard CPU and virtual frequency. Therefore, the system administrator can design the system without having to consider what type of CPU is installed in a server module.

Alternatively, the performance conversion data section 137 may be excluded from the system. If no performance conversion data is available, the type and frequency of a CPU installed in each server module 100 are to be specified as the system configuration information.

The aforementioned error, which occurs if the assignment of a server module 100 matching the system configuration information fails, will now be described.

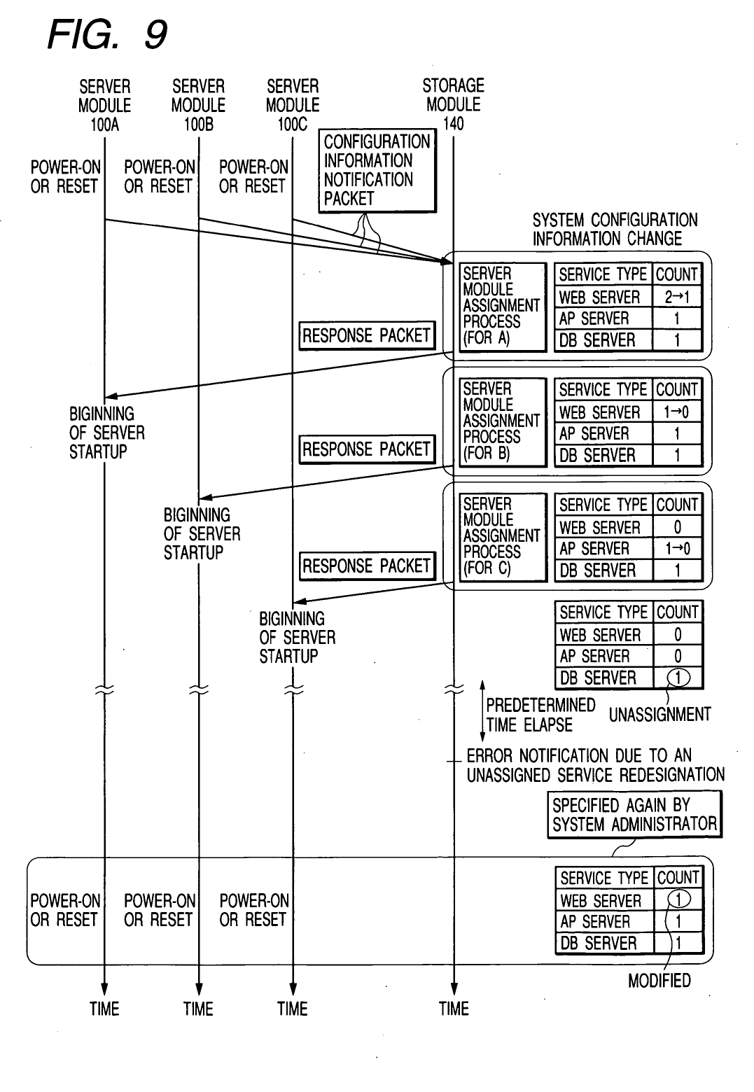

FIG. 9 shows a sequence that is followed in a situation where the storage module 140 sequentially performs service assignment in accordance with the system configuration information when three server modules (100A, 100B, and 100C) are reset or powered up.

This sequence assumes that two Web servers, one AP server, and one DB server are defined in the system configuration information.

First, the storage module 140 receives a configuration information notification packet from each of the three server modules. Server module 100A first matches the system configuration information and is assigned as a Web server. In this instance, the count included in the system configuration information is decremented by one from 2 and set to 1. Upon completion of assignment, a response packet is transmitted to server module 100A.

Next, server module 100B matches the system configuration information and is assigned as a Web server. In this instance, the count included in the system configuration information is decremented by one from 1 and set to 0. Upon completion of assignment, a response packet is transmitted to server module 100B.

Next, server module 100C matches the system configuration information and is assigned as an AP server. In this instance, the count included in the system configuration information is decremented by one from 1 and set to 0. Upon completion of assignment, a response packet is transmitted to server module 100C.

Server module assignment for the three units (100A to 100C) is now completed. However, the total number of server modules predefined by the system configuration information is 4. Therefore, one unit is left unassigned. The storage module 140 waits for the arrival of a configuration information notification packet from a server module 100. However, if the configuration information notification packet does not arrive within a predetermined period of time, the management server 150 is notified of an error, which indicates that a service defined by the system configuration information is unassigned.

The management server 150 transmits an error description and a message that prompts the system administrator to specify the system configuration information again.

When the system administrator receives the above error, it is necessary to avoid the recurrence of the error bydecreasing the numerical value for an unassigned service, which is contained in the error description, or by noting the execution requirements stated in the system configuration information about the unassigned service, which is contained in the error description, and reducing the number of service types entailing larger number of execution conditions than a service type in error. As regards the example shown in FIG. 8, the recurrence of the error is avoided by setting the number of Web servers to 1, thereby resetting the number of server modules required for the whole system to 3.

In the first embodiment of the present invention, which is configured as described above, the storage module can automatically assign services to the server modules to achieve system construction in accordance with the system configuration information predesigned by the system administrator. Further, the use of the performance conversion data enables the system administrator to accomplish system construction simply by setting the number of servers modeled with reference to a standard CPU, virtual frequency, and the like and without having to take the actual hardware configuration into consideration.

The second embodiment of the information processing system will now be described with reference to the accompanying drawings.

The second embodiment differs from the first embodiment in that the employed configuration permits server module logical partitioning. Components functionally identical with the counterparts described in conjunction with the first embodiment are assigned the same reference numerals as their counterparts and will not be described again.

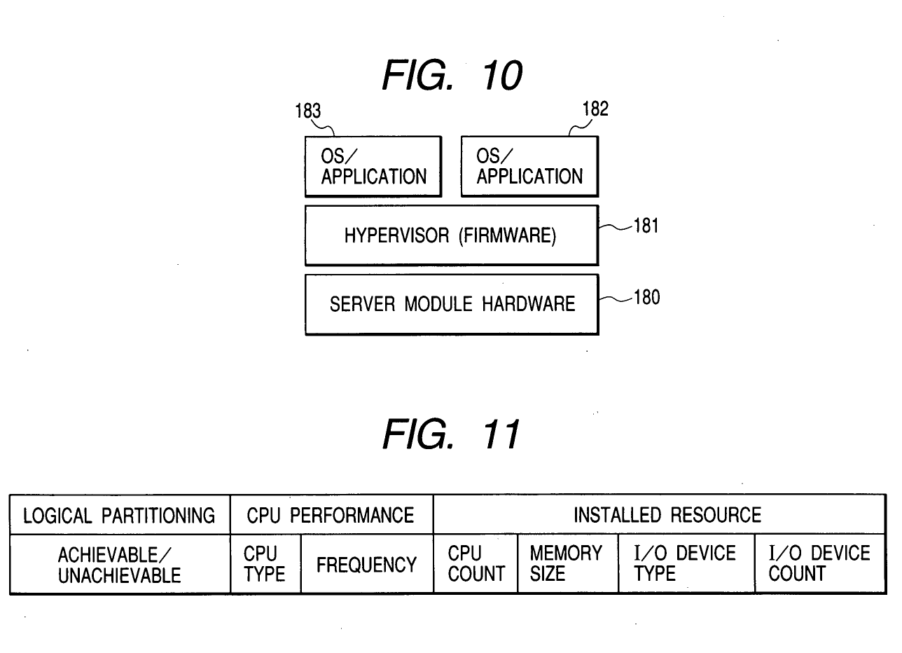

In the second embodiment, the hardware 180 for a server module 100 is provided with firmware 181 called a “hypervisor” as shown in FIG. 10. The configuration employed for the second embodiment is such that a single server module is divided into a plurality of logical partitions (LPARs), which can be independently used to simultaneously run OSes and applications 182, 183.

The hypervisor controls the CPU performance, installed CPU count, memory size, I/O devices, and other items to be assigned individually to the above OSes and applications 182, 183. A single piece of hardware 180 can be operated as a device having two or more different sets of configuration information.

FIG. 11 shows the configuration information that a server module 100 according to the present embodiment conveys with a configuration information notification packet.

The configuration information is provided with a logical partition field, which contains information indicating whether the server module can be logically partitioned. The information set for a server module provided with the above hypervisor 181 indicates that the server module can be logically divided into logical partition fields. Upon receipt of such information, the storage module 140 handles the server module as the~one having a plurality of LPARs. If the logical partition field contains information indicating that logical partitioning is unachievable, the storage module 140 handles the server module as a single server module.

The configuration of the second embodiment has been described thus far. The operation of the second embodiment will now be described.

When the storage module 140 receives a configuration information notification packet that contains information indicating that logical partitioning is achievable, the CPU, memory, and I/O devices installed on the server module 100 can be divided into arbitrary combinations and assigned to a plurality of OSes and applications.

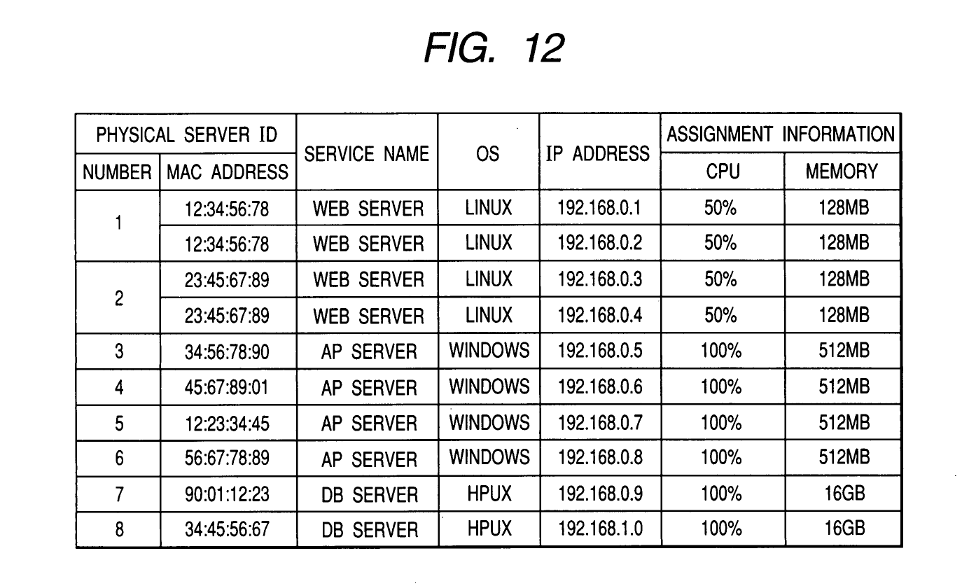

At the time of referencing the storage module 140 references the system configuration information, the storage module 140 assigns services to individual LPARs if it concludes that the CPU performance and installed resource values are greater than those required for individual service executions, that is, the total server module requirement values for the execution of a plurality of services. The storage module 140 stores the association between the assigned services and LPARs in a server use log (which will be described later with reference to FIG. 12) in the server use log section 135, reads data concerning the services from the storage 120, sets a host name and other server-specific items of information for individual services, and then transmits the data as a single response packet to a single server module 100.

Upon receipt of the response packet, the server module 100 causes the hypervisor 181 to generate LPARs in accordance with the execution conditions contained in the response packet, and starts OSes and applications as appropriate for the individual LPARs.

FIG. 12 shows an example of a server use log that is stored in the server use log section 135 of the storage module 140.

The server use log is used to record a set of a “physical server ID”, which consists of a number identifying a physical server module and a MAC address unique to an NIC for the server module, an assigned “service name”, an assigned “OS”, an “IP address” set for the Os, and the “assignment information” about a server module resource (CPU performance and memory) for use with an individual service.

The example shown in FIG. 12 indicates that the physical ID numbers 1 and 2 are both assigned to two Web servers by logical partitioning while the other physical servers are not logically partitioned. The assignment information column indicates that the Web servers having the physical ID number 1 or 2 each use 50% of the CPU resource and 128 MB of memory.

In the second embodiment of the information processing system, which is configured as described above, a single server module can be logically partitioned and handled as a plurality of server modules. Therefore, the system administrator can design the system without having to consider the number of server modules.

If, for instance, the total number of server modules is changed due to replacement for an update, the storage module can automatically assign appropriate services depending on the performance of each server module. Further, when the performance conversion data is used as the system configuration information, the system administrator can design the system without having to consider the performance and the number of server modules.

The third embodiment of the information processing system will now be described with reference to the accompanying drawings.

In the first and second embodiments, a server module 100 transmits a configuration information notification packet to the storage module 140, and then the storage module 140 constructs the system in accordance with the packet. In the third embodiment, however, the storage module 140 transmits an OS startup request packet to the server modules 100, and a server module 100 matching the contents of the packet transmits a match packet (or a mismatch packet) to the storage module 140 for system construction purposes. Components functionally identical with the counterparts described in conjunction with the first or second embodiment are assigned the same reference numerals as their counterparts and will not be described again.

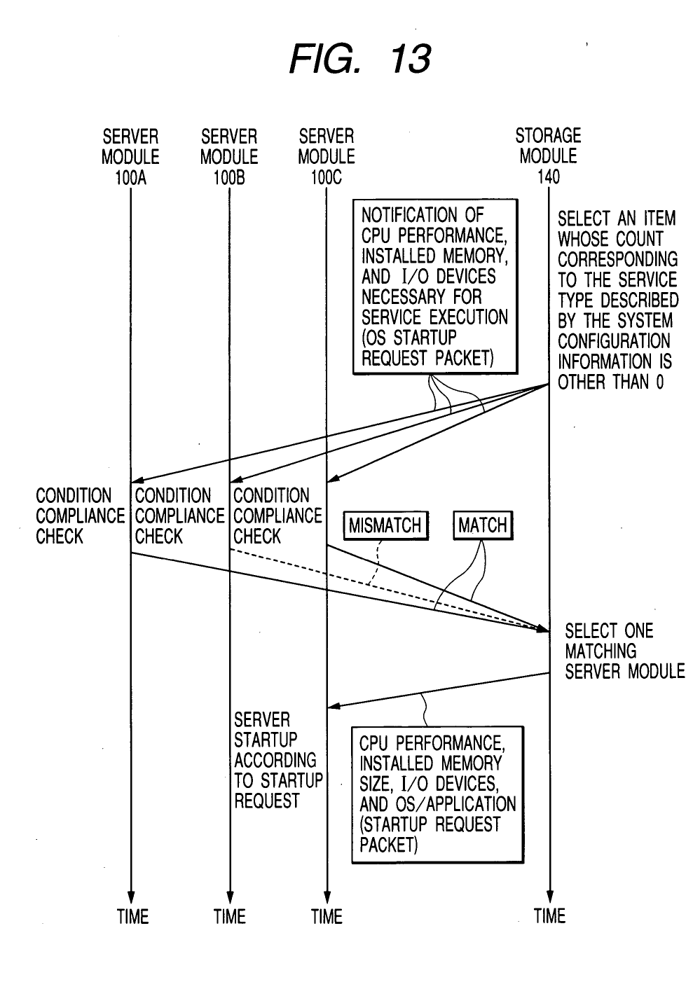

FIG. 13 is a sequence diagram illustrating a processing sequence that is performed by the third embodiment of the information processing system.

First of all, a server module 100 transmits a startup notification to notify the storage module 140 that the server module 100 is reset or powered up.

Upon receipt of the startup notification from the server module 100, the storage module 140 references the system configuration information (see FIG. 6), as it now knows that the server module 100 is reset or powered up, in order to check whether any service type is unassigned (the “count” is not 0). If all the service types are already assigned (all the “count” value are 0), the storage module 140 terminates the process because all services are already started.

If any service type is unassigned, the storage module 140 generates an OS startup request packet, which includes service execution conditions for the unassigned service type, and transmits it to all server modules 100 connected to the network module 110. The OS startup request packet contains the same information as the configuration information notification packet (FIG. 5).

Upon receipt of the OS startup request packet, the server modules 100 compares the execution requirements contained in the packet against their own performance characteristics (CPU type, installed CPU count, installed memory size, I/O devices, etc.) to judge whether the requirements are met (they are a match or mismatch). The server modules 100 transmit their judgment results to the storage module 140 in the form of a response packet. In the example shown in FIG. 13, server modules 100A and 100C both transmit a “match” response packet, whereas server module 100B transmits a “mismatch” response packet.

The storage module 140 receives the response packets, reads their contents, and selects one server module 100 that satisfies the service execution conditions (has returned a “match” response packet). When one server module 100 is selected in this manner, the storage module 140 decrements the corresponding service count within the system configuration information by one. If all the response packets indicate a “mismatch”, the storage module 140 reports an error to the management server 150.

Next, the storage module 140 accesses the storage 120 to read a service (OS, application, etc.) corresponding to the OS startup request packet to be transmitted to the selected server module 100, generates a startup request packet by setting up a host name and other server-specific items of information, and transmits the startup request packet to the above-mentioned server module. In the example shown in FIG. 13, the startup request packet is transmitted to server module 100C.

Upon receipt of the startup request, the server module (100C) starts up in accordance with the OS and application contained in the packet.

System construction is accomplished when the above process is performed, causing the storage module 140 to transmit an OS startup request packet to the server modules 100 and a service module 100 matching the contents of the packet to transmit a “match” packet (or a “mismatch” packet) to the storage module 140.

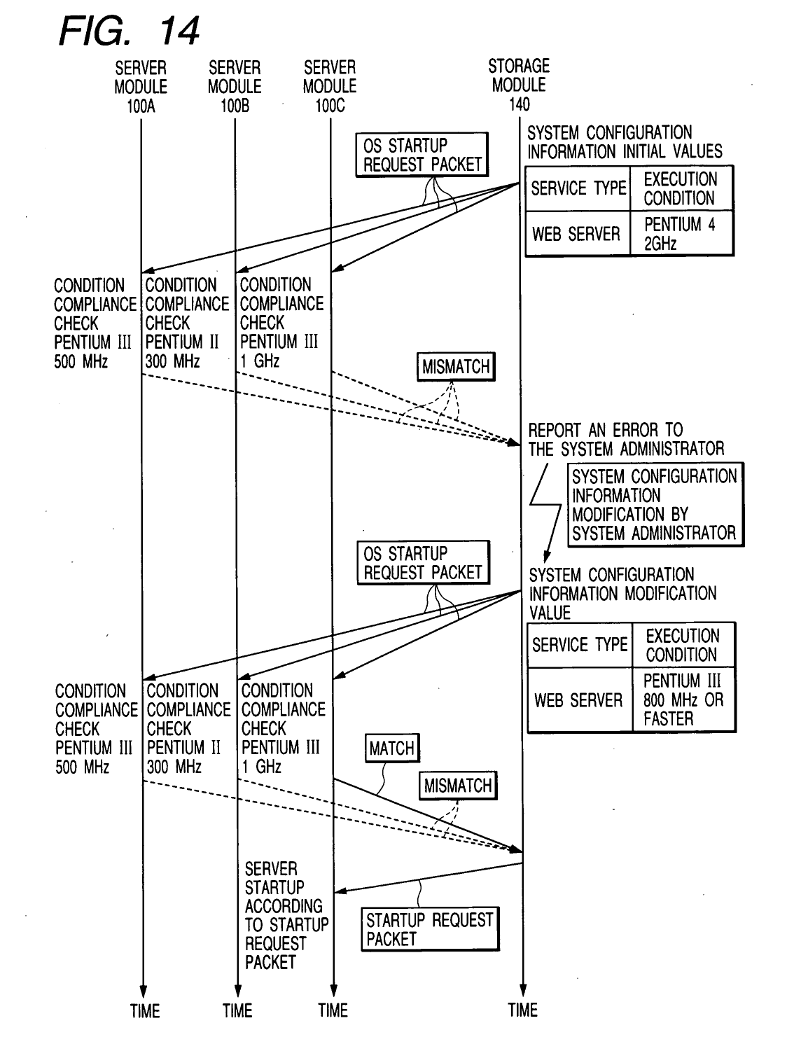

FIG. 14 shows a sequence that is followed when an error handling process is performed in a situation where all the response packets indicate a “mismatch”.

In the example shown in FIG. 14, the storage module 140 transmits an OS startup request packet, which designates a Web server as a service type and a 2 GHz Pentium 4 CPU as an execution condition. However, no existing server modules 100 satisfy these execution requirements so that all the response packets returned from the server modules 100 indicate a “mismatch”. Therefore, the storage module 140 reports an error to the management server 150.

The management server 150 not only reports the description of the error to the system administrator but also conveys a message that prompts for system configuration information modification. In this instance, the system administrator modifies the system configuration information so as to designate an 800 MHz or faster Pentium III process as an-execution condition.

In accordance with the modified system configuration information, the storage module 140 transmits an OS startup request packet again. Since the execution requirements contained in the packet are satisfied by server module 100C only, server module 100C is the only server module that transmits a “match” response packet. Upon receipt of the response packet, the storage module 140 accesses the storage 120 to read a service (OS, application, etc.) corresponding to the OS startup-request packet to be transmitted to server module 100C, generates a startup request packet by setting up a host name and other server-specific items of information, and transmits the startup-request packet to server module 100C. Server module 100C can then start a Web server.

The present embodiment is similar to the first embodiment in that the performance conversion data (FIG. 8) can be used.

The performance conversion data can be used according to either of the following two methods. One method is to let the OS startup request packet generated by the storage module 140 contain the performance conversion data. The other method is to store the performance conversion data on the side of the server modules 100 and use it to check whether the service execution requirements for the server modules are satisfied.

In a situation where the performance conversion data is stored on the side of the server modules 100, the performance conversion data is used upon receipt of the OS startup request packet to convert the locally installed CPU type and CPU frequency into the frequency ratio to a standard CPU, multiply the resulting frequency ratio by the actual frequency to obtain the standard CPU frequency equivalent, and render a match/mismatch judgment by comparing the obtained equivalent against the CPU performance specified by the OS startup request packet.

In the third embodiment, which is configured as described above, the storage module searches for unassigned services and the server modules check whether the service execution requirements are satisfied. Therefore, the third embodiment has the same advantage as the first embodiment in that the storage module can automatically assign services to the server modules to achieve system construction in accordance with the system configuration information predesigned by the system administrator. Further, the use of the performance conversion data enables the system administrator to accomplish system construction simply by setting the number of servers modeled with reference to a standard CPU, virtual frequency, and the like and without having to take the actual hardware configuration into consideration.

The fourth embodiment of the information processing system will now be described.

The fourth embodiment is similar to the second embodiment in that the employed configuration permits logical partitioning of server modules (see FIG. 10). Components functionally identical with the counterparts described in conjunction with the first, second, or third embodiments are assigned the same reference numerals as their counterparts and will not be described again.

Upon receipt of an OS startup request packet from the storage module 140, the server modules 100 check whether the service execution requirements contained in the packet are satisfied, and transmit the check result to the storage module 140 in the form of a response packet. Upon receipt of the response packet, the storage module 140 selects one server module that satisfies the service execution requirements, and transmits a startup request packet to the server module 100. This startup request packet comprises a service (OS, application, etc.) corresponding to the OS startup request packet and the information about CPU performance and installed resource, which is recorded in the OS startup request packet.

Upon receipt of the startup request packet, the server module 100 causes the hypervisor (FIG. 10) to generate an LPAR having CPU performance and installed resource required for service execution, and runs an OS, application, and others contained in the startup request packet on the LPAR.

If the server module 100 receives another OS startup request packet, it uses CPU performance and installed resource other than those allocated to the above LPARs to check whether the service execution requirements stated within the OS startup request packet are satisfied.

When, in this instance, it is found that the service execution requirements are satisfied, the server module 100 generates a new LPAR and executes an OS, application, and others contained in the startup request packet.

The fourth embodiment, which is configured as described above, not only provides the same advantage as the third embodiment but is also capable of logically partitioning a single server module 100 to handle the resulting partitions as a plurality of server modules 100. Therefore, the system administrator can design the system without having to consider the number of server modules 100.

What is claimed is:

1. An information processing system in which a plurality of server modules and a storage module, which comprises a storage device for storing a service to be executed by said server modules and a controller for controlling said storage device, are interconnected via a network,
wherein said storage module comprises a system configuration information retention database for retaining system configuration information including the information about the configuration of server modules necessary for the execution of said service and the number of server modules to which said service is to be assigned;
wherein said server modules comprise a configuration information transmission unit for transmitting configuration information about the server modules to said storage module at the time of starting the server modules; and
wherein said storage module comprises a comparison routine for comparing the configuration information transmitted by said configuration information transmission unit against the system configuration information retained by said system configuration information retention database, and gives, in accordance with the result of comparison made by said comparison routine, a host-name, which is unique to the information processing system, to a server module from which the configuration information is transmitted, assigns a service included in the system configuration information to the server module, transmits data for executing the service, and updates the number of server modules to which said service, which is included in said system configuration information, is to be assigned.

2. The information processing system according to claim 1, wherein said server modules retransmit said configuration information if said storage module fails to transmit data for executing a service even when a predetermined period of time elapses after said configuration is transmitted-by said configuration information transmission unit, and comprises an error reporting routine for reporting a response error if a predetermined retransmission count is exceeded.

3. The information processing system according to claim 1, comprising an error report routine for reporting an unassigned error if the number of server modules, to which said service, which is included in said system configuration information, is to be assigned, fails to reach a predetermined value within a predetermined period of time after said storage module transmits data for executing a service to said server modules.

4. The information processing system according to claim 2, comprising an alarm routine for prompting a system administrator to modify said system configuration information if said response error or said unassigned error is reported.

5. The information processing system according to claim 1, wherein the configuration information transmitted by said configuration information transmission unit includes a standardized CPU name and standardized CPU performance information; wherein said storage module comprises a conversion information retention unit for retaining conversion information necessary for conversion between server module CPU performance information and standardized CPU performance information required for running said service and a conversion routine for converting CPU performance information included in said configuration information in accordance with said conversion information; and wherein said comparison routine compares CPU performance information converted by said conversion routine and corresponding information retained by said corresponding information retention unit.

6. The information processing system according to claim 1, comprising a logical partitioning routine for logically partitioning a resource of said server modules,
wherein said configuration information includes information that indicates whether the server modules can be logically partitioned; and
wherein said storage module assigns a service included in said system configuration information to each one of a plurality of logically partitioned units.

7. A server module which is connected via a network to a storage module, which comprises a storage device for storing a service to be executed by the server module and a controller for controlling said storage device, the server module comprising:
a configuration information transmission unit for transmitting configuration information about the server module to said storage module when the server module starts up;
a reception unit for receiving data for service execution by the server module and a host name unique to the information processing system, which are both transmitted from said storage module; and
a service start routine for starting the service in accordance with the received data.

8. A storage module which is connected to a plurality of server modules via a network and equipped with a storage device for storing a service to be executed by said server modules and a controller for controlling said storage device, the storage module comprising:
a system configuration information retention unit for retaining system configuration information including the information about the configuration of server modules necessary for the execution of said service and the number of server modules to which said service is to be assigned,
wherein said server modules comprise a configuration information transmission unit for transmitting configuration information about the server modules to said storage module at the time of starting the server modules; and
wherein said storage module comprises a comparison routine for comparing configuration information about said server modules, which is transmitted by the server modules, and the system configuration information retained by said system configuration information retention unit, and gives, in accordance with the result of comparison made by said comparison routine, a host name, which is unique to the information processing system, to a server module from which the configuration information is transmitted, assigns a service included in the system configuration information to the server module, transmits data for executing the service, and updates the number of server modules to which said service, which is included in said system configuration information, is to be assigned.

9. A system construction method for use in an information processing system in which a plurality of server modules and a storage module, which comprises a storage device for storing a service to be executed by said server modules and a controller for controlling said storage device, are interconnected via a network,
wherein said server modules transmit configuration information about the server modules to said storage module at the time of starting the server modules;
wherein said storage module compares configuration information transmitted from said server modules against system configuration information including information about the configuration of server modules necessary for the execution of said service and the number of server modules to which said service is to be assigned; and gives, in accordance with the result of the above comparison, a host name, which is unique to the information processing system, to a server module from which the configuration information is transmitted, assigns a service included in the system configuration information to the server module, transmits data for executing the service, and updates the number of server modules to which said service, which is included in said system configuration information, is to be assigned.

10. The system construction method according to claim 9, comprising the steps of:
retransmitting said configuration information if the data for service execution is not transmitted from said storage module within a predetermined time after the transmission of said configuration information; and
reporting a response error if said retransmission is performed more than a predetermined number of times.

11. The system construction method according to claim 9, comprising a step of reporting an “unassigned” error if the number of server modules, to which said service, which is included in said system configuration information, is to be assigned, fails to reach a predetermined value within a predetermined period of time after said storage module transmits data for executing a service to said server modules.

12. An information processing system in which a plurality of server modules and a storage module, which comprises a storage device for storing a service to be executed by said server modules and a controller for controlling said storage device, are interconnected via a network,
wherein said storage module comprises a system configuration information retention unit for retaining system configuration information including the information about the configuration conditions for server modules necessary for the execution of said service and the number of server modules operating said service; and a configuration condition request transmission means for transmitting to said server modules, at startup of the server modules, a configuration condition request including the request for the configuration of server modules necessary for the execution of said service; and
wherein said server modules comprise a comparison routine for comparing the configuration of a server module against a server module configuration required for the execution of said service, which is transmitted to the server module; and a response routine for transmitting response information, which indicates whether requirements specified by said configuration condition request are met, to said storage module in accordance with the result of comparison made by said comparison routine; and
wherein said storage module gives, in accordance with said response information, a host name, which is unique to the information processing system, to a server module from which the response information is transmitted, assigns a service included in the system configuration information to the server module, transmits data for executing the service, and updates the number of server modules to which said service, which is included in said system configuration information, is to be assigned.

13. The information processing system according to claim 12, comprising an error report routine for reporting a configuration condition error if none of said response information meets the requirements specified by said configuration condition request.

14. The information processing system according to claim 12, comprising an error report routine for reporting an “unassigned” error if the number of server modules, to which said service, which is included in said system configuration information, is to be assigned, fails to reach a predetermined value within a predetermined period of time after said storage module transmits data for executing a service to said server modules.

15. The information processing system according to claim 13, comprising an alarm routine for prompting a system administrator to modify said system configuration information if said configuration condition error or said “unassigned” error is reported.

16. The information processing system according to claim 12, wherein configuration information request information transmitted by said configuration condition request transmission unit comprises a standardized CPU name, standardized CPU performance information, and conversion information that is necessary for conversion between server module CPU performance information and standardized CPU performance information required for running said service; and
wherein said server modules comprise a conversion unit for converting CPU performance information included in said configuration information request information in accordance with said conversion information; and wherein said comparison unit compares CPU performance information converted by said conversion unit and corresponding information retained by said corresponding information retention unit.

17. The information processing system according to claim 12, comprising:
a logical partitioning routine for logically dividing a resource of said server modules,
wherein said response information includes information that indicates whether the server modules can be logically partitioned; and
wherein said storage module assigns a service included in said system configuration information to each one of a plurality of logically partitioned units.

18. A server module that is connected via a network to a storage module, which comprises a storage device for storing a service to be executed by a server module and a controller for controlling said storage device, the server module comprising:
a startup notification unit for notifying said storage module of server module startup;
a reception unit for receiving, from said storage module, a configuration condition request including the request for the configuration of a server module that is transmitted at startup of said server module and necessary for the execution of said service for the server module;
a comparison unit for comparing the configuration of the server module against a server module configuration required for the execution of said service, which is transmitted to the server module;
a response unit for transmitting response information, which indicates whether requirements specified by said configuration condition request are met, to said storage module in accordance with the result of comparison made by said comparison unit;
a reception unit for receiving data for service execution by the server module and a host name unique to the information processing system, which are both transmitted from said storage module; and
a service start unit for starting the service in accordance with the received data.

19. A storage module which is connected to a plurality of server modules via a network and equipped with a storage device for storing a service to be executed by said server modules and a controller for controlling said storage device, the storage module comprising:
a system configuration information retention unit for retaining system configuration information including the information about server module configuration conditions required for the execution of said service and the number of server modules operating said service; and
a configuration condition request transmission unit for transmitting, at the time of starting said server modules, a configuration condition request including the request for server module configuration required for executing said service for the server modules,
wherein said storage module provides, in accordance with response information that is transmitted from said server modules to indicate whether requirements specified by said configuration condition request are met, a host name, which is unique to the information processing system, to a server module from which the response information is transmitted, assigns a service included in the system configuration information to the server module, transmits data for executing the service, and updates the number of server modules to which said service, which is included in said system configuration information, is to be assigned.

20. A method for use in an information processing system in which a plurality of server modules and a storage module, which comprises a storage device for storing a service to be executed by said server modules and a controller for controlling said storage device, are interconnected via a network, the method comprising:
sending a notification from said server modules to notify said storage module of server module startup;
transmitting from said storage module at said server module startup, a configuration condition request including the request for server module configuration required for the execution of said service to the server modules;
comparing in said server modules the configuration of a server module against the server module configuration required for the execution of said service for the server module, and
transmitting, in accordance with the result of said comparison, response information to said storage module in order to indicate whether requirements specified by said configuration condition request are met; and
providing from said storage module, in accordance with said response information, a host name, which is unique to the information processing system, to a server module from which the response information is transmitted,
assigning a service included in the system configuration information to the server module,
transmitting data for executing the service, and
updating the number of server modules to which said service which is included in said system configuration information is to be assigned.

21. The system construction method according to claim 20, further comprising reporting a configuration condition error if none of said response information meets the requirements specified by said configuration condition request.

22. The system construction method according to claim 20, further comprising:
reporting an “unassigned” error if the number of server modules, to which said service which is included in said system configuration information is to be assigned, fails to reach a predetermined value within a predetermined period of time after said storage module transmits data, for executing a service to said server modules.

23. The information processing system according to claim 3, comprising an alarm routine for prompting a system administrator to modify said system configuration information if said response error or said “unassigned” error is reported.

24. The information processing system according to claim 13, comprising an error report routine for reporting an “unassigned” error if the number of server modules, to which said service, which is included in said system configuration information, is to be assigned, fails to reach a predetermined value within a predetermined period of time after said storage module transmits data for executing a service to said server modules.

25. The method of claim 20 wherein the service is an operating system and/or application.
